(19) United States
(12) Patent Application Publication
(10) Pub. No.: US 2012/0019476 A1
(43) Pub. Date: Jan. 26, 2012

(54) CAPACITIVE TOUCH PANEL

(75) Inventors: Woon Chun Kim, Gyunggi-do (KR); Yong Soo Oh, Gyunggi-do (KR); Hyun Jun Kim, Gyunggi-do (KR); Jong Young Lee, Gyunggi-do (KR)

(73) Assignee: SAMSUNG ELECTRO-MECHANICS CO., LTD., Gyunggi-do (KR)

(21) Appl. No.: 12/951,846

(22) Filed: Nov. 22, 2010

(30) Foreign Application Priority Data
Jul. 26, 2010 (KR) 1020100072064

(51) Int. Cl. G06F 3/045

(52) U.S. Cl. 345/174

(57) ABSTRACT

Disclosed herein is a capacitive touch panel including: a transparent substrate, a transparent electrode formed on the transparent substrate, the transparent electrode being made of a conductive polymer, a transparent protective layer formed on the transparent electrode, the transparent protective layer having transparent characteristics, and a transparent adhesive formed on the transparent protective layer. According to the present invention, the transparent protective layer is further formed between the transparent electrode and the transparent adhesive to prevent reactivity between the transparent electrode and the transparent adhesive, thereby making it possible to improve operation reliability of the touch panel.

### CROSS REFERENCE TO RELATED APPLICATION

This application claims the benefit of Korean Patent Application No. 10-2010-0072064, filed on Jul. 26, 2010, entitled “Capacitive Type Touch Panel”, which is hereby incorporated by reference in its entirety into this application.

### BACKGROUND OF THE INVENTION

1. Technical Field

The present invention relates to a capacitive touch panel.

2. Description of the Related Art

Alongside the growth of computers using digital technology, devices assisting computers have also been developed, and personal computers, portable transmitters and other personal information processors execute processing of text and graphics using a variety of input devices such as a keyboard and a mouse.

While the rapid advancement of the information-based society has been widening the use of computers more and more, there have been occurring the problems of it being difficult to efficiently operate products using only the keyboard and mouse as being currently responsible for the input device function. Thus, the demand for a device that is simple, does not malfunction, and has the capability to easily input information is increasing.

Furthermore, current techniques for input devices exceed the level of fulfilling general functions and thus are progressing towards techniques related to high reliability, durability, innovation, designing and manufacturing. To this end, a touch panel has been developed as an input device capable of inputting information such as text and graphics.

The touch panel is mounted on the display surface of an image display device such as an electronic organizer, a flat panel display including a liquid crystal display (LCD) device, a plasma display panel (PDP), an electroluminescence (El) element or the like, or a cathode ray tube (CRT), so that a user selects the information desired while viewing the image display device.

The touch panel is classifiable as a resistive type, a capacitive type, an electromagnetic type, a surface acoustic wave (SAW) type, and an infrared type. The type of touch panel selected is one that is adapted for an electronic product in consideration of not only signal amplification problems, resolution differences and the degree of difficulty of designing and manufacturing technology but also in light of optical properties, electrical properties, mechanical properties, resistance to the environment, input properties, durability and economic benefits of the touch panel. In current, the capacitive type is most prevalently used in a broad range of fields.

The capacitive touch panel uses a conductive polymer in order to form a transparent electrode and uses a transparent adhesive in order to bond an upper substrate of the capacitive touch panel to a lower substrate thereof. However, when the transparent adhesive is used in order to bond the upper substrate of the capacitive touch panel to the lower substrate thereof, various problems arise, in particular, the conductive polymer reacts with the transparent adhesive. More specifically, the resistance of the conductive polymer is increased due to the change in the physical property of conductive polymer according to the reaction between the conductive polymer and the transparent adhesive and the visibility of the touch panel is degraded due to the reduction in transparency. In addition, an electromigration (EM) phenomenon that electrons move between the conductive polymer and the transparent adhesive is generated. The EM phenomenon is a phenomenon that metal components move crossing the top or the inside of a non-metal medium due to the effects of electric field. This phenomenon is commonly generated under a dry environment at a high temperature of 150° or more, such that temperature condition and environment for forming the transparent electrode of the conductive polymer may further expedite the generation of such EM phenomenon. Subsequently, as the EM phenomenon is generated between the conductive polymer and the transparent adhesive, the physical property of the conductive polymer may be changed, thereby degrading operation reliability of the capacitive touch panel.

### SUMMARY OF THE INVENTION

The present invention has been made in an effort to provide a touch panel capable of preventing resistance from increasing due to a change in a physical property of a conductive polymer forming a transparent electrode and improving visibility of the touch panel by further forming a transparent protective layer between transparent adhesives bonded to the transparent electrode.

A capacitive touch panel according to a preferred embodiment of the present invention includes: a transparent substrate; a transparent electrode formed on the transparent substrate, the transparent electrode being made of a conductive polymer; a transparent protective layer formed on the transparent electrode, the transparent protective layer having transparent characteristics; and a transparent adhesive formed on the transparent protective layer.

Herein, the conductive polymer includes poly-3, 4-ethylenedioxythiophene/polystyrenesulfonate (PEDOT/PSS), polyaniline, polyacetylene, or polyphenylenevinylene.

Further, the transparent protective layer is made of silicon dioxide (SiO₂), titanium dioxide (TiO₂), or zinc dioxide (ZnO₂).

Further, the transparent adhesive is an optically clear adhesive (OCA).

A capacitive touch panel according to another preferred embodiment of the present invention includes: an upper substrate including a first transparent substrate, a first transparent electrode formed on the first transparent substrate, the first transparent electrode being made of a conductive polymer, and a first transparent protective layer formed on the first transparent electrode; and a lower substrate including a second transparent substrate, a second transparent electrode formed on the second transparent substrate, the second transparent electrode being made of a conductive polymer, and a second transparent protective layer formed on the second transparent electrode, wherein the upper substrate and the lower substrate are bonded to each other using a transparent adhesive so that the first transparent protective layer and the second transparent protective layer face each other.

Herein, the conductive polymer includes poly-3, 4-ethylenedioxythiophene/polystyrenesulfonate (PEDOT/PSS), polyaniline, polyacetylene, or polyphenylenevinylene.

Further, the first transparent protective layer or the second transparent protective layer is made of silicon dioxide (SiO₂), titanium dioxide (TiO₂), or zinc dioxide (ZnO₂).

Further, the transparent adhesive is an optically clear adhesive (OCA).

### BRIEF DESCRIPTION OF THE DRAWINGS

FIG. 1 is an exploded view of a capacitive touch panel according to a preferred embodiment of the present invention.

### DESCRIPTION OF THE PREFERRED EMBODIMENTS

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. In the description, the terms “first”, “second”, and so on are used to distinguish one element from another element, and the elements are not defined by the above terms. Further, in describing the present invention, a detailed description of related known functions or configurations will be omitted so as not to obscure the subject of the present invention.

Hereinafter, preferred embodiments of the present invention will be described in detail with reference to the accompanying drawings.

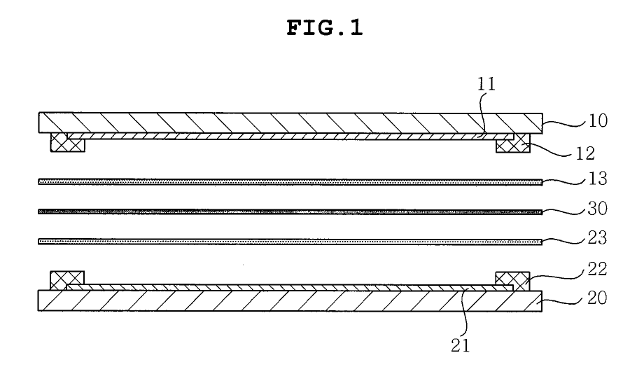

FIG. 1 is an exploded view of a capacitive touch panel according to a preferred embodiment of the present invention. The capacitive touch panel according to the present invention includes a transparent substrate, a transparent electrode formed on the transparent substrate, the transparent electrode being made of a conductive polymer, a transparent protective layer formed on the transparent electrode, the transparent protective layer having transparent characteristics, and a transparent adhesive formed on the transparent protective layer.

The material of the transparent substrate is not particularly limited, if having a predetermined strength or more, but may include polyethyleneterephthalate (PET), polycarbonate (PC), polymethylmethacrylate (PMMA), polyethylenenaphthalate (PEN), polyethersulfone (PES), cyclic olefin polymer (COC), triacetylcellulose (TAC) film, polyvinyl alcohol (PVA) film, polyimide (PI) film, polystyrene (PS), biaxially oriented polystyrene (BOPS; containing K resin), glass or tempered glass and so on. In addition, the transparent electrode is formed on one surface of the transparent substrate, such that a surface treatment layer may be formed on one surface of the transparent substrate by performing a high frequency treatment, a primer treatment or the like thereon in order to improve adhesion between the transparent substrate and the transparent electrode.

The transparent electrode serves to generate signals when a touch panel is touched by a user to allow a controller (not shown) to recognize coordinates thereof. The transparent electrode is formed on one surface of the transparent substrate. Herein, the transparent electrode is made of a conductive polymer. The conductive polymer may include poly-3, 4-ethylenedioxythiophene/polystyrenesulfonate (PEDOT/PSS), polyaniline, polyacetylene, or polyphenylenevinylene, but is not particularly limited thereto. The present invention is to prevent visibility of a touch panel from being degraded due to a chemical reaction according to a contact between the conductive polymer forming the transparent electrode and a transparent adhesive to be described below or electromigration (EM) or to prevent conductivity from being degraded according to the change in a physical property of the conductive polymer, that is, increase in resistance.

The transparent protective layer is to prevent a reaction occurring between the transparent electrode and the transparent adhesive. It is preferable that the transparent protective layer is made of a material having low reactivity. In addition, the transparent protective layer should be made of a transparent material in consideration of visibility of the touch panel. The transparent protective layer uses a material having high dielectric constant, thereby making it possible to improve sensing sensitivity when the touch panel is touched. The transparent protective layer may be made of silicon dioxide (SiO₂), titanium dioxide (TiO₂), or zinc dioxide (ZnO₂). However, the transparent protective layer may also be made using various materials if they are transparent materials having low reactivity and high dielectric constant.

The transparent adhesive is formed to bond the transparent substrates on which the transparent electrodes are formed to each other or bond the transparent substrate to a window. In particular, the transparent adhesive in the present invention reacts with the conductive polymer to degrade function of the touch panel. In order to prevent this, the transparent adhesive further includes the transparent protective layer formed thereon. The material of the transparent adhesive is not particularly limited but may include any material generating a chemical reaction or an electromigration (EM) when bonding to the conductive polymer. As the transparent adhesive, an optically clear adhesive (OCA) may be used.

As shown in FIG. 1, the capacitive touch panel according to a preferred embodiment of the present invention includes an upper substrate including a first transparent substrate 10, a first transparent electrode 11 formed on the first transparent substrate 10, the first transparent electrode 11 being made of a conductive polymer, and a first transparent protective layer 13 formed on the first transparent electrode 11; and a lower substrate including a second transparent substrate 20, a second transparent electrode 21 formed on the second transparent substrate 20, the second transparent electrode 21 being made of a conductive polymer, and a second transparent protective layer 23 formed on the second transparent electrode 21, wherein the upper substrate and the lower substrate are bonded to each other using a transparent adhesive 30 so that the first transparent protective layer 13 and the second transparent protective layer 23 face each other.

The description of the transparent substrate, the transparent electrode, the transparent protective layer, and the transparent adhesive is similarly applied to the present embodiment, such that the overlapping description will be omitted.

The first transparent protective layer 13 or the second transparent protective layer 23 according to the present invention may be formed on the upper substrate or the lower substrate, such that the transparent protective layer may also be selectively formed depending on reactivity between the conductive polymer that is a transparent electrode material and the transparent adhesive 30. However, FIG. 1 shows an embodiment in which the first transparent protective layer 13 and the second transparent protective layer 23 are formed on the upper substrate and the lower substrate, respectively.

According to the present invention, the transparent protective layer is further formed between the transparent electrode and the transparent adhesive to prevent reactivity between the transparent electrode and the transparent adhesive, thereby making it possible to improve operation reliability of the touch panel.

In addition, the transparent protective layer is further formed to improve dielectric constant, thereby making it possible to improve sensing sensitivity of the input on the touch panel.

In addition, the transparent protective layer is further formed to prevent a chemical reaction between the transparent electrode and the transparent adhesive and thus, to prevent visibility of the touch panel from being degraded due to compounds or the like, thereby making it possible to maintain visibility to be stable.

In addition, the transparent protective layer is further formed to prevent the electro migration (EM) phenomenon of the transparent adhesive and thus, to prevent the physical property of the conductive polymer forming the transparent electrode from being changed, thereby making it possible to prevent resistance of the conductive polymer from being increased.

Although the preferred embodiments of the present invention have been disclosed for illustrative purposes, they are for specifically explaining a capacitive touch panel according to the present invention are not limited thereto, but those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. A capacitive touch panel, comprising:
a transparent substrate;
a transparent electrode formed on the transparent substrate, the transparent electrode being made of a conductive polymer;
a transparent protective layer formed on the transparent electrode, the transparent protective layer having transparent characteristics; and
a transparent adhesive formed on the transparent protective layer.

2. The capacitive touch panel as set forth in claim 1, wherein the conductive polymer includes poly-3, 4-ethylenedioxythiophene/polystyrenesulfonate (PEDOT/PSS), polyaniline, polyacetylene, or polyphenylenevinylene.

3. The capacitive touch panel as set forth in claim 1, wherein the transparent protective layer is made of silicon dioxide (SiO₂), titanium dioxide (TiO₂), or zinc dioxide (ZnO₂).

4. The capacitive touch panel as set forth in claim 1, wherein the transparent adhesive is an optically clear adhesive (OCA).

5. A capacitive touch panel, comprising:
an upper substrate including a first transparent substrate, a first transparent electrode formed on the first transparent substrate, the first transparent electrode being made of a conductive polymer, and a first transparent protective layer formed on the first transparent electrode; and
a lower substrate including a second transparent substrate, a second transparent electrode formed on the second transparent substrate, the second transparent electrode being made of a conductive polymer, and a second transparent protective layer formed on the second transparent electrode,
wherein the upper substrate and the lower substrate are bonded to each other using a transparent adhesive so that the first transparent protective layer and the second transparent protective layer face each other.

6. The capacitive touch panel as set forth in claim 5, wherein the conductive polymer includes poly-3, 4-ethylenedioxythiophene/polystyrenesulfonate (PEDOT/PSS), polyaniline, polyacetylene, or polyphenylenevinylene.

7. The capacitive touch panel as set forth in claim 5, wherein the first transparent protective layer or the second transparent protective layer is made of silicon dioxide (SiO₂), titanium dioxide (TiO₂), or zinc dioxide (ZnO₂).

8. The capacitive touch panel as set forth in claim 5, wherein the transparent adhesive is an optically clear adhesive (OCA).
